(19) United States
(12) Patent Application Publication
(10) Pub. No.: US 2026/0086279 A1
(43) Pub. Date: Mar. 26, 2026

(54) TECHNOLOGIES FOR LOW-CROSSTALK MULTILAYER WAVEGUIDE STACKS

(71) Applicant: Intel Corporation, Santa Clara, CA (US)

(72) Inventors: Nada J. Sekeljic, Hillsboro, OR (US); Georgios C. Dogiamis, Chandler, AZ (US); Adel Elsherbini, Chandler, AZ (US); Feras Eid, Chandler, AZ (US); Henning Braunisch, Phoenix, AZ (US); Veronica Strong, Hillsboro, OR (US); Brandon M. Rawlings, Chandler, AZ (US); James E. Jaussi, El Dorado Hills, CA (US); Haisheng Rong, Pleasanton, CA (US)

(73) Assignee: Intel Corporation, Santa Clara, CA (US)

(21) Appl. No.: 18/897,368

(22) Filed: Sep. 26, 2024

(51) Int. Cl. G02B 6/12

(52) U.S. Cl. CPC G02B 6/12002

(57) ABSTRACT

Technologies for a compact and low-crosstalk multilayer waveguide stack are disclosed. In an illustrative embodiment, a photonic integrated circuit (PIC) die includes a 3D array of waveguides arranged in a multilayer stack. Individual waveguides have a propagation constant different from the propagation constant of neighboring waveguides, which can reduce crosstalk between neighboring waveguides. In an illustrative embodiment, the propagation constant can be controlled by changing the width of individual waveguides. In other embodiments, the propagation constant can be controlled by changing any suitable parameter, such as the height of the waveguides, the core of the waveguides, the cladding of the waveguides, etc.

### BACKGROUND

Photonic integrated circuits (PICs) can be used for several applications, such as communications. PIC dies may include components such as waveguides, filters, light sources, detectors, etc. Photonic waveguides in a PIC die may be arranged in a two-dimensional pattern. To increase data throughput, additional waveguides may be added. However, if the waveguides get too close, there can be crosstalk between the waveguides. In some cases, additional layers of waveguides may be added. However, if the layers are not thick enough, waveguides in one layer may have crosstalk with waveguides in the layers above or below them.

### BRIEF DESCRIPTION OF THE DRAWINGS

FIG. 1 is an isometric view of an integrated circuit component including a photonic integrated circuit (PIC) die and an electronic integrated circuit (EIC) die.

FIG. 2 is a cross-sectional view of one embodiment of the integrated circuit component of FIG. 1.

FIG. 3 is a top-down view of one embodiment of the PIC die of FIG. 1.

FIG. 4 is a cross-sectional view of one embodiment of the PIC die of FIG. 1.

FIG. 5 is a cross-sectional view of one embodiment of the PIC die of FIG. 1.

FIG. 6 is a cross-sectional view of one embodiment of the PIC die of FIG. 1.

FIG. 7 is a cross-sectional view of one embodiment of the PIC die of FIG. 1.

FIG. 8 is a plot showing a phase constant of a waveguide as a function of waveguide width.

FIG. 9 is a plot showing maximum crosstalk between waveguides as a function of phase constant mismatch.

FIG. 10 is a simplified flow diagram of at least one embodiment of a method for manufacturing an integrated circuit component including a PIC die and an EIC die.

FIG. 11 is a cross-sectional view of one embodiment of the PIC die at one point in the method of manufacturing of the flow diagram of FIG. 10.

FIG. 12 is a cross-sectional view of one embodiment of the PIC die at one point in the method of manufacturing of the flow diagram of FIG. 10.

FIG. 13 is a cross-sectional view of one embodiment of the PIC die at one point in the method of manufacturing of the flow diagram of FIG. 10.

FIG. 14 is a cross-sectional view of one embodiment of the PIC die at one point in the method of manufacturing of the flow diagram of FIG. 10.

FIG. 15 is a top view of a wafer and dies that may be included in a microelectronic assembly, in accordance with any of the embodiments disclosed herein.

FIG. 16 is a cross-sectional side view of an integrated circuit device that may be included in a microelectronic assembly, in accordance with any of the embodiments disclosed herein.

FIGS. 17A-17D are perspective views of example planar, gate-all-around, and stacked gate-all-around transistors.

FIG. 18 is a cross-sectional side view of an integrated circuit device assembly that may include a microelectronic assembly, in accordance with any of the embodiments disclosed herein.

FIG. 19 is a block diagram of an example electrical device that may include a microelectronic assembly, in accordance with any of the embodiments disclosed herein.

### DETAILED DESCRIPTION

In various embodiments disclosed herein, an integrated circuit component includes a photonic integrated circuit (PIC) die and an electronic integrated circuit (EIC) die. The PIC die may include a 3D array of waveguides defined in a stack of dielectric layers. The waveguides in the 3D array of waveguides may have a propagation constant that is different from the propagation constant of neighboring waveguides, reducing crosstalk between neighboring waveguides, even if the distance between the waveguides is relatively small. The propagation constant may be different between neighboring waveguides due to, e.g., different cross-sectional profiles of the waveguides, different core materials, and/or different cladding materials for the waveguides. Because the waveguides with different propagation constants can be closer together, the PIC die can carry higher bandwidth in a smaller area or volume.

As used herein, the phrase “communicatively coupled” refers to the ability of a component to send a signal to or receive a signal from another component. The signal can be any type of signal, such as an input signal, an output signal, or a power signal. A component can send or receive a signal to another component to which it is communicatively coupled via a wired or wireless communication medium (e.g., conductive traces, conductive contacts, air). Examples of components that are communicatively coupled include integrated circuit dies located in the same package that communicate via an embedded bridge in a package substrate and an integrated circuit component attached to a printed circuit board that send signals to or receives signals from other integrated circuit components or electronic devices attached to the printed circuit board.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact, and “coupled” may indicate elements co-operate or interact, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term. For example, the central axis of a magnetic plug that is substantially coaxially aligned with a through hole may be misaligned from a central axis of the through hole by several degrees. In another example, a substrate assembly feature, such as a through width, that is described as having substantially a listed dimension can vary within a few percent of the listed dimension.

It will be understood that in the examples shown and described further below, the figures may not be drawn to scale and may not include all possible layers and/or circuit components. In addition, it will be understood that although certain figures illustrate transistor designs with source/drain regions, electrodes, etc. having orthogonal (e.g., perpendicular) boundaries, embodiments herein may implement such boundaries in a substantially orthogonal manner (e.g., within +/−5 or 10 degrees of orthogonality) due to fabrication methods used to create such devices or for other reasons.

Reference is now made to the drawings, which are not necessarily drawn to scale, wherein similar or same numbers may be used to designate the same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

As used herein, the phrase “located on” in the context of a first layer or component located on a second layer or component refers to the first layer or component being directly physically attached to the second part or component (no layers or components between the first and second layers or components) or physically attached to the second layer or component with one or more intervening layers or components.

As used herein, the term “adjacent” refers to layers or components that are in physical contact with each other. That is, there is no layer or component between the stated adjacent layers or components. For example, a layer X that is adjacent to a layer Y refers to a layer that is in physical contact with layer Y.

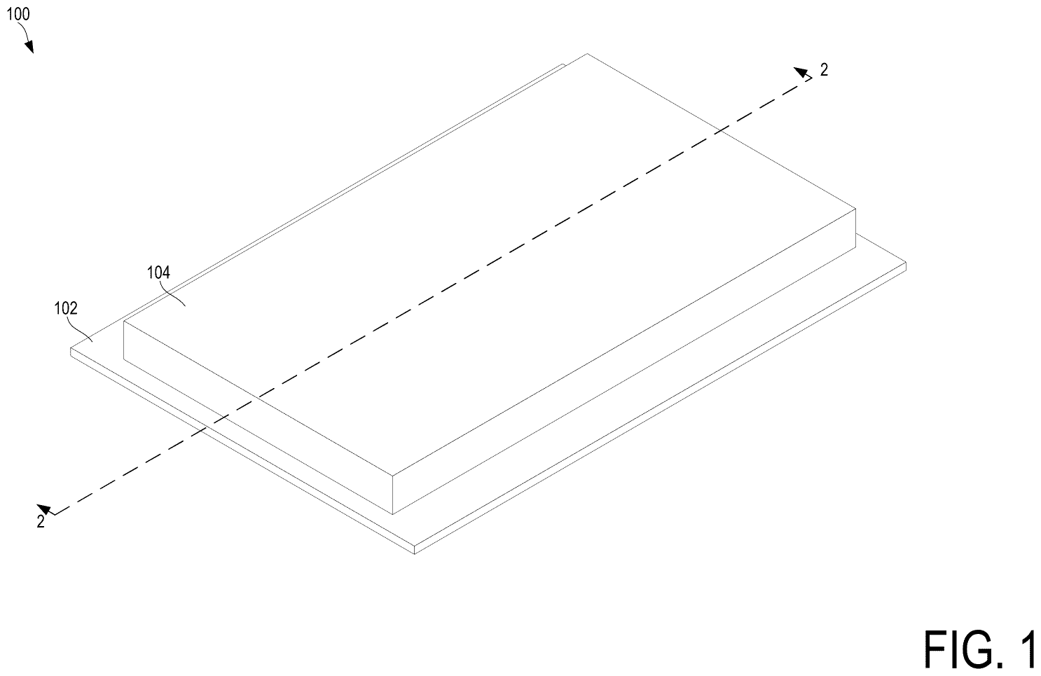

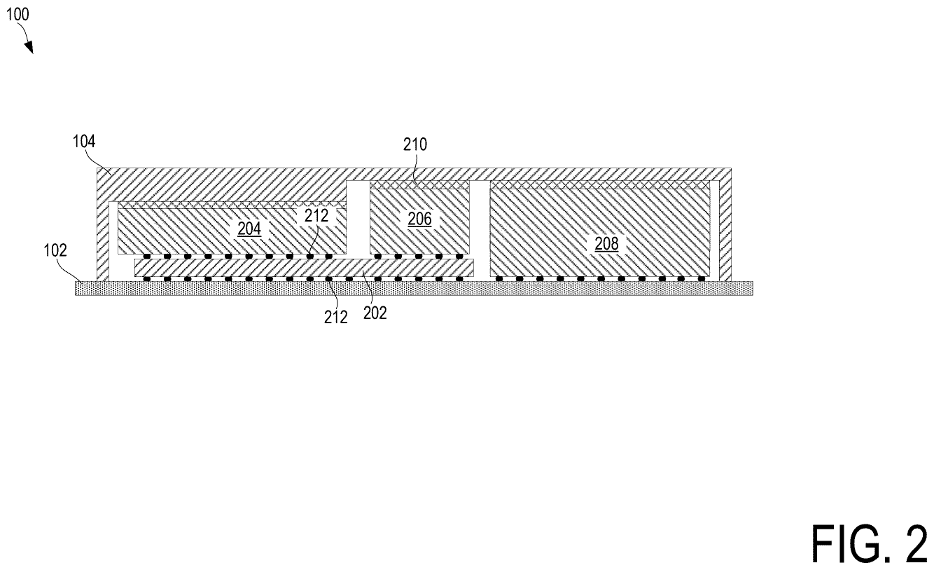

Referring now to FIGS. 1 and 2, in one embodiment, an integrated circuit component 100 includes a circuit board 102, an EIC die 202, a PIC die 204, and an integrated heat spreader 104. FIG. 1 shows a perspective view of the integrated circuit component 100, and FIG. 2 shows a cross-sectional view of one embodiment of the integrated circuit component 100. In an illustrative embodiment, the EIC die 202 is mounted on the circuit board 102, and the PIC die 204 is mounted on the EIC die 202. The integrated circuit component 100 may include other components, such as other EIC dies 206, 208. The other EIC dies 206, 208 may be, e.g., an XPU, a memory die or memory package, and/or the like.

In an illustrative embodiment, the EIC die 202 and EIC die 208 are connected to the circuit board 102 with solder balls 212, and the EIC die 206 and PIC die 204 are connected to the EIC die 202 with solder balls 212. In other embodiments, the EIC die 202 and PIC die 204 may be connected using hybrid bonding. A thermal interface material (TIM) 210 is between the PIC die 204 and EIC dies 206, 208 and the integrated heat spreader 104.

The illustrative circuit board 102 may be made from ceramic, glass, and/or organic-based materials with fiberglass and resin, such as FR-4. The circuit board 102 may have any suitable length or width, such as 10-500 millimeters. The circuit board 102 may have any suitable thickness, such as 0.2-5 millimeters. The circuit board 102 may support additional components besides the components shown in FIGS. 1 and 2, such as additional photonic or electronic integrated circuit components, a memory device, additional circuit components, etc.

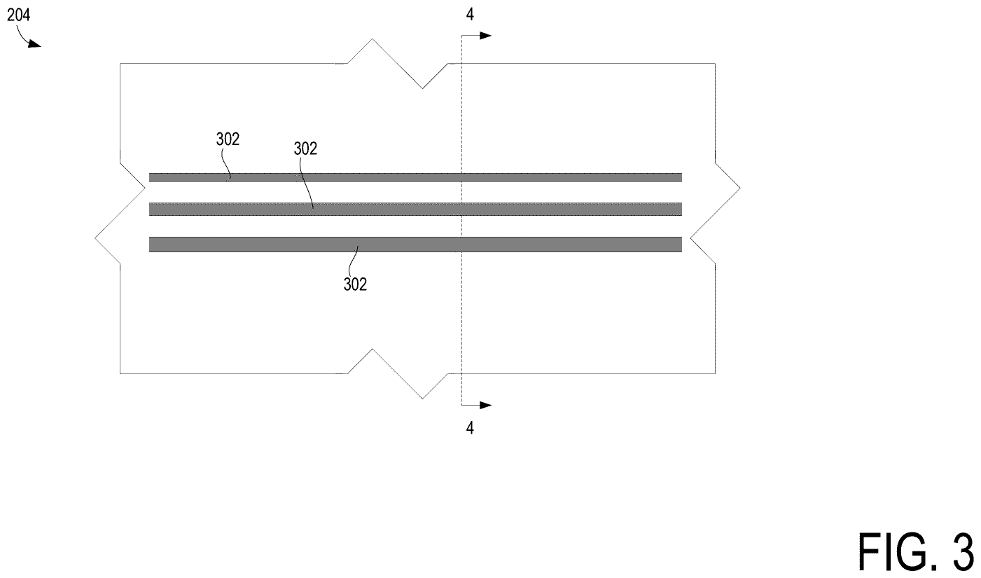

The PIC die 204 may be made of any suitable material, such as silicon. In the illustrative embodiment, waveguides, such as waveguides 302 discussed below in regard to FIG. 3, may be silicon waveguides embedded in silicon oxide cladding. The PIC die 204 may include any suitable number of waveguide inputs and/or outputs, such as 1-1,024. Other optical components, such as optical fibers and/or optical interposers, may be connected to the PIC die 204 to provide optical signals into and out of the waveguides of the PIC die 204. Components such as optical fibers may extend from the integrated circuit component 100, such as through the integrated heat spreader 104 and/or through the circuit board 102 (not shown in FIGS. 1 and 2).

The PIC die 204 is configured to generate, detect, and/or manipulate light. The PIC die 204 may include active or passive optical elements such as splitters, couplers, filters, optical amplifiers, lasers, photodetectors, modulators, etc.

The EIC die 202 may include any suitable electronic integrated circuit component, such as resistors, capacitors, inductors, transistors, etc. The EIC die 202 may include any suitable analog and/or digital circuitry, such as a processor, a memory, an application-specific integrated circuit (ASIC), a field-programmable gate array (FPGA), etc. In some embodiments, the integrated circuit component 100 may be embodied as or otherwise include a router, a switch, a network interface controller, and/or the like. In such embodiments, the EIC die 202 may include network interface controller circuitry to process, parse, route, etc., network packets sent and received by the integrated circuit component 100. Similarly, the EIC dies 206, 208 may be any suitable embodiment of the EIC die 202 described above in combination with any suitable embodiment of the EIC die 202.

The EIC dies 202, 206, 208 and/or the PIC die 204 may have any suitable length or width, such as 1-300 millimeters. The EIC dies 202, 206, 208 and/or the PIC die 204 may have any suitable thickness, such as 0.05-5 millimeters.

The integrated heat spreader 104 may be made of any suitable material with a high thermal conductivity, such as copper, aluminum, other metals, metal alloys, coated metals, combinations of metals, etc. In an illustrative embodiment, the integrated heat spreader 104 is nickel-plated copper. In use, a heat sink with fins or another heat transfer component, such as a liquid-cooled cold plate, may be mated with the integrated heat spreader 104 to remove heat.

The EIC die 202 and/or the PIC die 204 may include any suitable number of solder balls 212, such as 1-10,000. The solder balls 212 may be arranged in any suitable pattern, such as a two-dimensional grid. The solder balls 212 may have any suitable size, such as 10-1,000 micrometers, and any suitable pitch, such as 25 to 1,500 micrometers. The solder balls 212 may be made of or otherwise include any suitable type of solder, such as tin/lead solder, a lead-free solder, a high-temperature solder, etc. The solder balls 212 may include by weight, e.g., 0-50% lead, 0-97% tin, 0-50% silver, 0-5% copper, 0-85% gold, or any suitable combination thereof. The melting point of the solder balls 212 may be, e.g., 180-400° C., depending on the particular application. The solder balls 212 may connect to an active component on the PIC die 204, such as a laser, an amplifier, a detector, a modulator, a switch, etc.

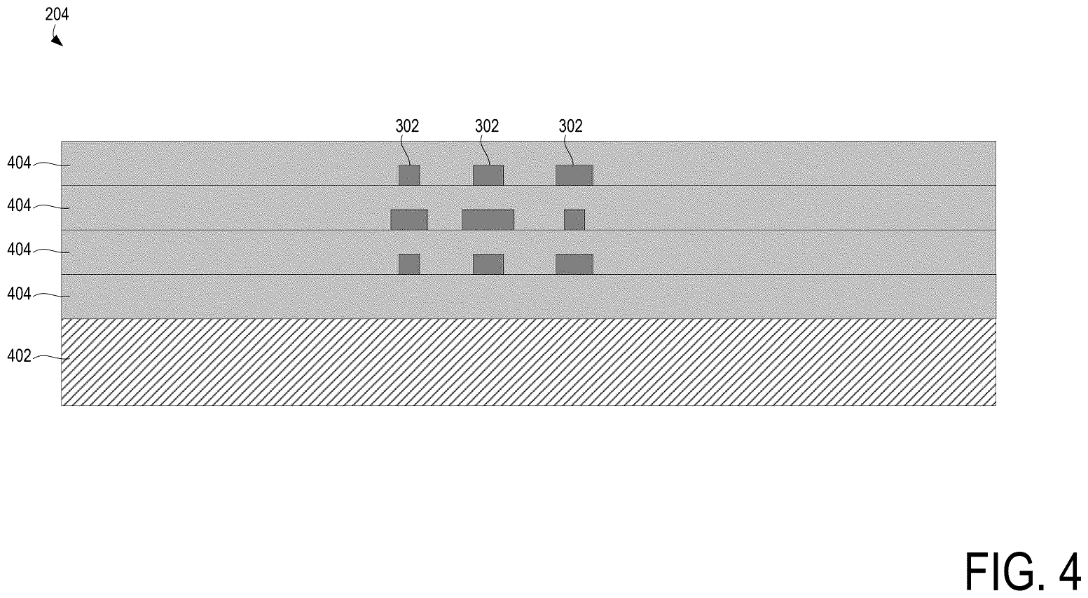

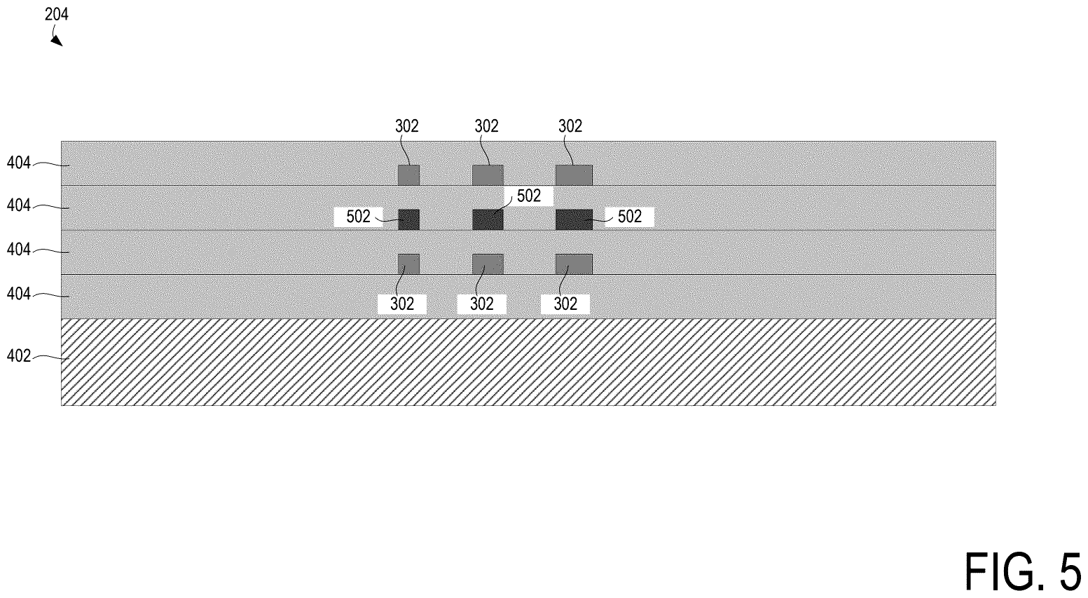

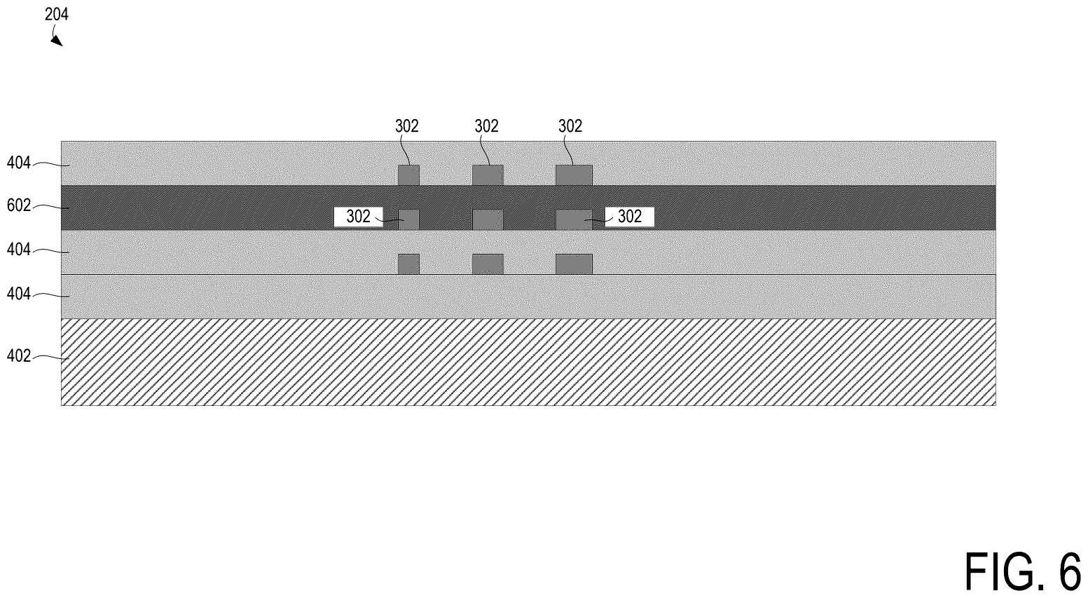

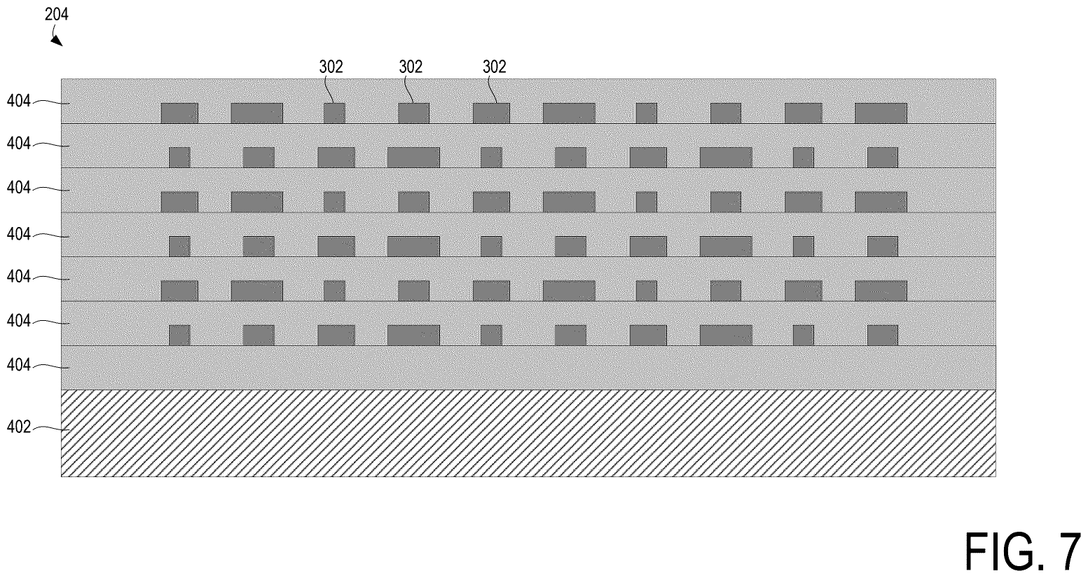

Referring now to FIGS. 3-7, various views of various embodiments of the PIC die 204 are shown. FIG. 3 shows a top view of part of one embodiment of a PIC die 204, FIG. 4 shows a cross-sectional side view of part of one embodiment of a PIC die 204, FIG. 5 shows a cross-sectional side view of part of one embodiment of a PIC die 204, FIG. 6 shows a cross-sectional side view of part of one embodiment of a PIC die 204, and FIG. 7 shows a cross-sectional side view of part of one embodiment of a PIC die 204. In FIG. 3, the waveguides extend across the page. In FIGS. 4-7, the waveguides extend into and out of the pages.

In an illustrative embodiment, the PIC die 204 includes a substrate layer 402 and a stack of dielectric layers 404 adjacent the substrate layer 402. In an illustrative embodiment, waveguides 302 are defined in some or all of the dielectric layers 404. The PIC die 204 may also include various other components, such as lasers, amplifiers, detectors, modulators, switches, filters, couplers, etc. The various waveguides of the PIC die 204 may be routed in three dimensions to various other components on the PIC die 204. Light may be coupled onto and off of the PIC die 204 in any suitable manner, such as direct coupling to other dies, butt-coupling of fibers or waveguides, grating coupling, vertical couplers, lens, mirrors, etc.

The various waveguides shown in FIG. 3 may have differing propagation constants and, in particular, may have propagation constants different enough from neighboring waveguides 302 (either on the same layer or an adjoining layer) that there is no significant crosstalk between neighboring waveguides 302. For example, as shown in FIG. 3, the waveguides 302 may have different widths from waveguides 302 that are immediately to the left, right, above, or below. Additionally or alternatively, in some embodiments, waveguides 502 in some layers may have a different core material than waveguides 302 in adjoining layers, as shown in FIG. 5. For examples, waveguides 502 may have a core of silicon nitride, while waveguides 302 may have a core of silicon, all in cladding of dielectric layers 404 of silicon oxide. In the embodiment shown in FIG. 5, neighboring waveguides 302, 502 on the same layer have different widths with the same core material, and neighboring waveguides 302, 502 on different layers have different core materials with the same width.

Additionally or alternatively, in some embodiments, a different cladding material may be used. For example, in one embodiment, a dielectric layer 602 may be a different material than adjacent dielectric layers 404, as shown in FIG. 6. For example, dielectric layers 404 may be silicon oxide, and dielectric layer 602 may be silicon nitride, with silicon waveguides 302 in each layer 404, 602. The different cladding material can change the propagation constant of the waveguides 302 enough that neighboring waveguides in different layers do not significantly couple to each other, even if the waveguides 302 have the same dimensions.

The three-dimensional array of waveguides 302 may include any suitable number of layers 404 of waveguides and any suitable number of waveguides 302 per layer 404. For example, in one embodiment, a PIC die 204 may include six layers of waveguides 302, with ten waveguides 302 per layer 404, as shown in FIG. 7.

In general, the propagation constant of the various waveguide 302 may be controlled in any suitable manner, such as by varying the height and/or width of the waveguide, varying the material of the core of the waveguide, varying the material of the cladding of the waveguide, and/or a combination of those factors. In some embodiments, some of the factors may be the same for waveguides 302 in a given dielectric layer 404. For example, in one embodiment, the core material, cladding material, and the height of the waveguides 302 may be the same in a given dielectric layer 404, and the width may be the only factor that varies between waveguides 302 in that layer 404. In other embodiments, a different factor or more than one factor may vary between waveguides 302 in the same layer 404.

In some embodiments, the parameters of waveguides 302 may repeat periodically, either in a layer or across the stack of layers. For example, in one embodiment, there may be four different widths of waveguides 302. A waveguide 302 of a particular width may be four waveguides 302 away from another waveguide 302 of that width. Although the waveguide 302 may have a propagation constant that matches that of a waveguide 302 that is four waveguides 302 away, there will not be significant coupling due to the high distance between them. An array of periodically repeating waveguides 302 in one layer 404 may be offset from an array of periodically repeating waveguides 302 in an adjacent layer 404. For example, if there is a superlattice of four different waveguide 302 widths in a repeating pattern in one layer 404, the superlattice of four different waveguide 302 widths in a repeating pattern in an adjacent layer 404 may be offset by two waveguides 302, separating waveguides 302 with the same propagation constant in different layers 404. An array of waveguides 302 may have any suitable number of waveguides in one unit cell of a superlattice, such as 1-8.

The waveguides 302, 502 may have any suitable pitch, either on the same layer or between layers, such as 0.8-5 microns. In some embodiments, the pitch between waveguides 302, 502 may be less than the vacuum wavelength of the operating wavelength of the waveguides 302, 502 and still achieve low crosstalk levels. In an illustrative embodiment, the crosstalk levels may be below, e.g., −30 decibels. In other embodiments, the crosstalk levels may be, e.g., −10 to −60 decibels. Without a mismatch between propagation constants, neighboring waveguides may otherwise need to be, e.g., two or more wavelengths away to achieve similar crosstalk levels. In general, the pitch may be any suitable fraction or multiple of the vacuum wavelength of the operating wavelength or cutoff wavelength of the waveguides 302, 502, such as 0.5-5 times the vacuum wavelength of the operating wavelength or cutoff wavelength of the waveguides 302, 502. In an illustrative embodiment, the vacuum wavelength of the operating wavelength of the waveguides 302, 502 is about 1,280-1,340 nanometers. In other embodiments, different wavelength ranges may be used, such as C-band, L-band, S-band, etc. In an illustrative embodiment, wavelength division multiplexing (WDM) may be used, with multiple wavelength channels in each waveguide 302, 502.

In an illustrative embodiment, the substrate layer 402 is silicon. In other embodiments, other suitable substrates may be used. The substrate layer 402 may have any suitable thickness, such as 40-5,000 micrometers.

In an illustrative embodiment, the dielectric layers 404 are silicon oxide and the waveguides 302 are silicon. In other embodiments, other suitable materials may be used for any of the dielectric layers 404, 602 and waveguides 302, 502, such as silicon, silicon nitride, silicon oxide, aluminum oxide, aluminum nitride, amorphous silicon, hafnium dioxide, polymers, III-V semiconductors, chalcogenides, lithium niobate, gallium nitride, air, various dopants, etc. Of course, it should be appreciated that the waveguides 302, 502 will be structured to guide light, such as by being a higher index than the adjacent dielectric cladding. In general, the core and/or cladding may have any suitable indices of refraction, such as 1.4-4. Neighboring waveguides may have a difference between their core indices of refraction and/or their cladding indices of refraction of any suitable amount, such as 0-30% and/or an absolute different in the index of refraction of 0-1.

In an illustrative embodiment, the dielectric layers 404, 602 are about 2 micrometers thick. In other embodiments, the dielectric layers 404, 602 may have any suitable thickness, such as 0.5-20 micrometers. The waveguides 302, 502 may have any suitable width and/or thickness, such as 0.2-20 micrometers. The difference in width and/or thickness between neighboring waveguides 302, 502 may be any suitable amount, such as 0-50%, depending on whether the difference in width and/or thickness is used to create a difference in the propagation constant between the waveguides and how much of a difference in the propagation constant is needed to achieve the target amount of crosstalk. In an illustrative embodiment, the height and width of the waveguides 302, 502 may be selected to support single-mode operation in the waveguides 302, 502, depending on the wavelength, index of refraction of the waveguides 302, 502, index of refraction of the cladding, polarization, etc. In other embodiments, the height and width of the waveguides 302, 502 may be selected to support multi-mode operation in the waveguides 302, 502. For example, in some embodiments, the PIC die 204 may use spatial mode-division multiplexing to increase the bandwidth carried per waveguide 302, 502.

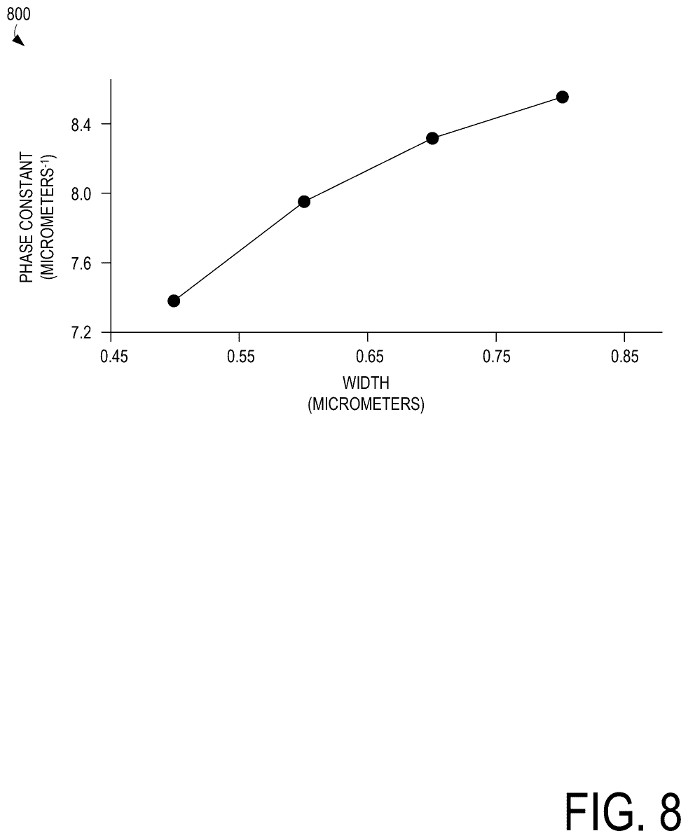

Referring now to FIG. 8, in one embodiment, a graph 800 shows a phase constant as a function of waveguide width for a fixed waveguide height and pitch. As shown in the graph 800, as the width increases, the phase constant changes. The dots on the plot are calculated data points, and the lines between the data points are interpolations.

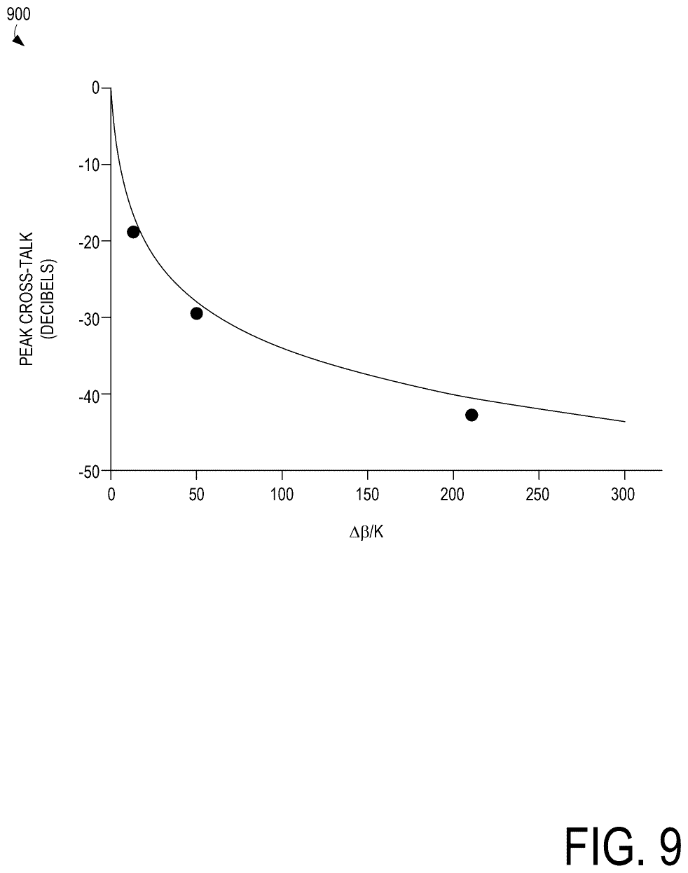

Referring now to FIG. 9, in one embodiment, a graph 900 shows peak crosstalk as a function of the ratio between the difference in propagation constant Db between two waveguides and the coupling constant k between the waveguides. The points on the graph 900 are calculated data points, and the line is an approximate formula. As shown in the graph 900, as the ratio increases, the peak crosstalk decreases. In general, the difference in propagation constant between two waveguides may be any suitable value, such as 0-5 inverse micrometers, and the coupling constant k between the waveguides may be any suitable value, such as 0-0.001 inverse micrometers.

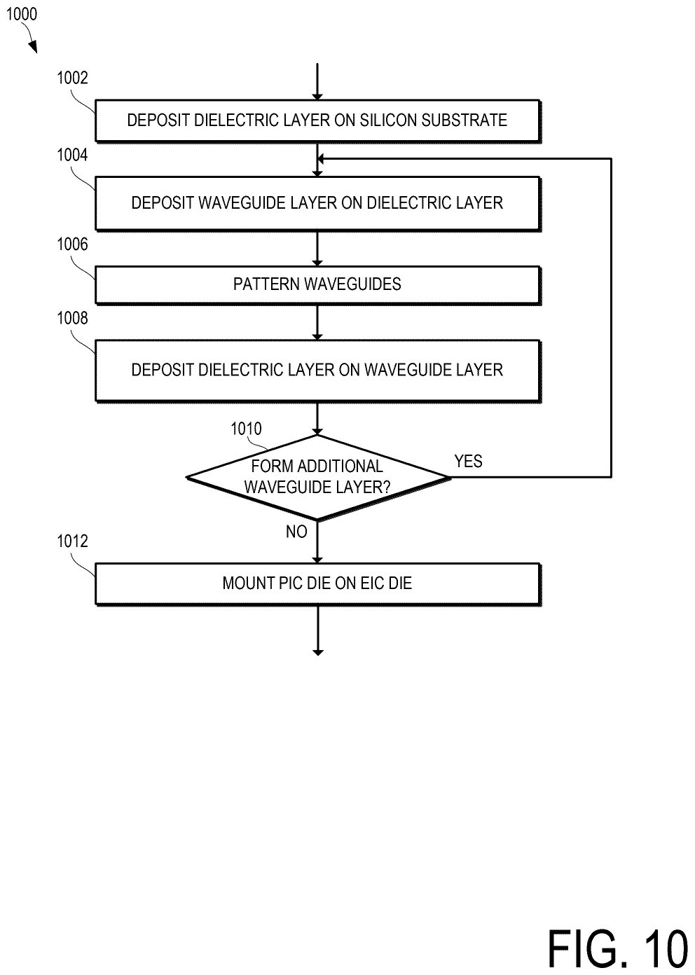

Referring now to FIG. 10, in one embodiment, a flowchart for a method 1000 for creating an integrated circuit component 100 is shown. The method 1000 may be executed by a technician and/or by one or more automated machines. In some embodiments, one or more machines may be programmed to do some or all of the steps of the method 1000. Such a machine may include, e.g., a memory, a processor, data storage, etc. The memory and/or data storage may store instructions that, when executed by the machine, cause the machine to perform some or all of the steps of the method 1000. The method 1000 may use any suitable set of techniques that are used in semiconductor processing, such as chemical vapor deposition, atomic layer deposition, physical layer deposition, molecular beam epitaxy, layer transfer, photolithography, ion implantation, dry etching, wet etching, selective laser etching, thermal treatments, flip chip, layer transfer, magnetron sputter deposition, pulsed laser deposition, etc. It should be appreciated that the method 1000 is merely one embodiment of a method to create one embodiment of the integrated circuit component 100, and other methods may be used to create any suitable embodiment of the integrated circuit component 100. In some embodiments, steps of the method 1000 may be performed in a different order than that shown in the flowchart.

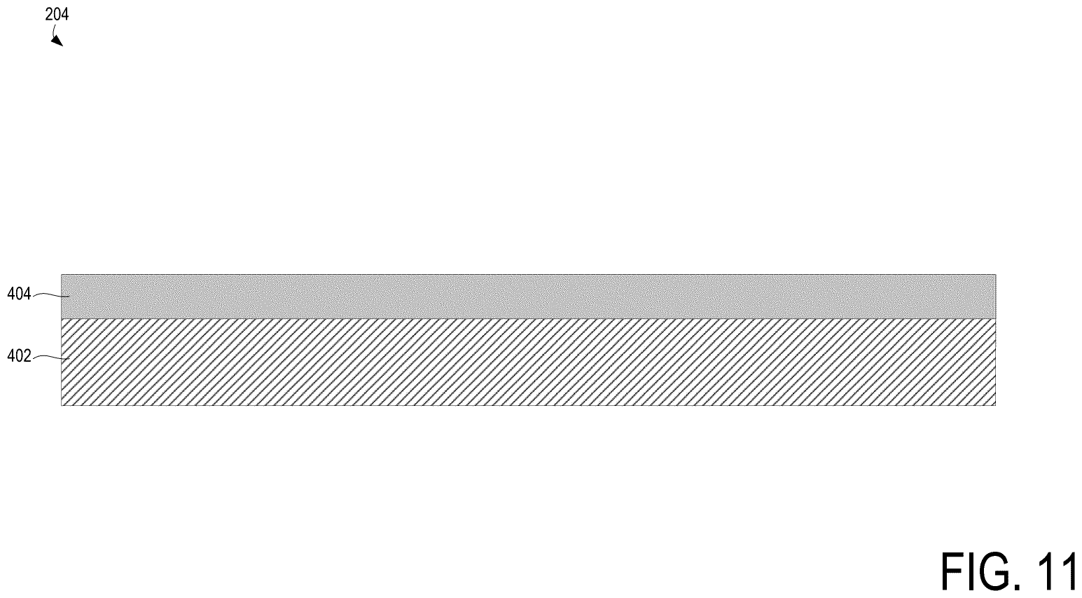

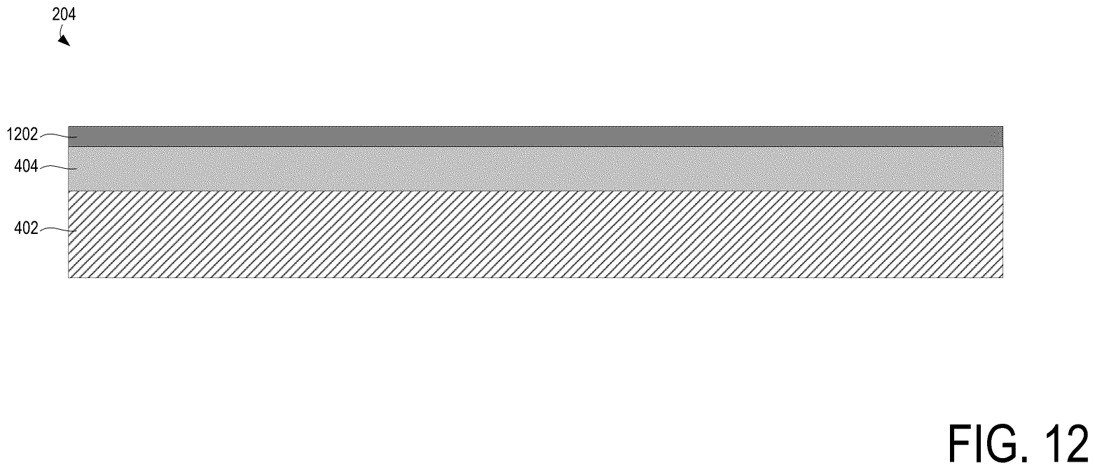

The method 1000 begins in block 1002, in which a dielectric layer 404 is deposited on a substrate layer 402, as shown in FIG. 11. In block 1004, a waveguide layer 1202 is deposited on the dielectric layer 404, as shown in FIG. 12. The waveguide layer 1202 may be grown directly on the dielectric layer 404 or the waveguide layer 1202 may be deposited on the dielectric layer 404 using, e.g., layer transfer.

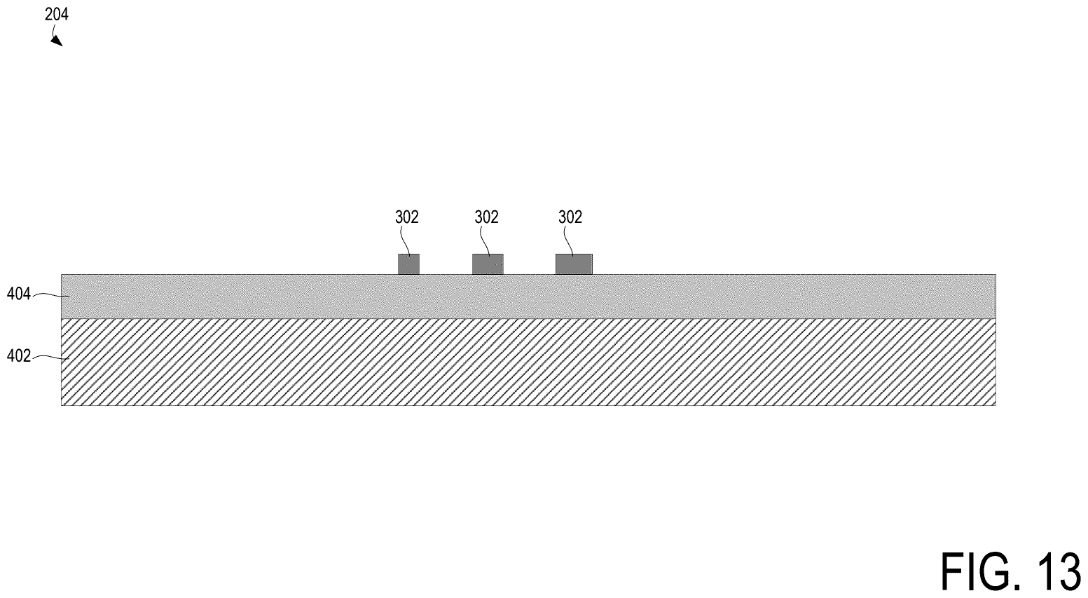

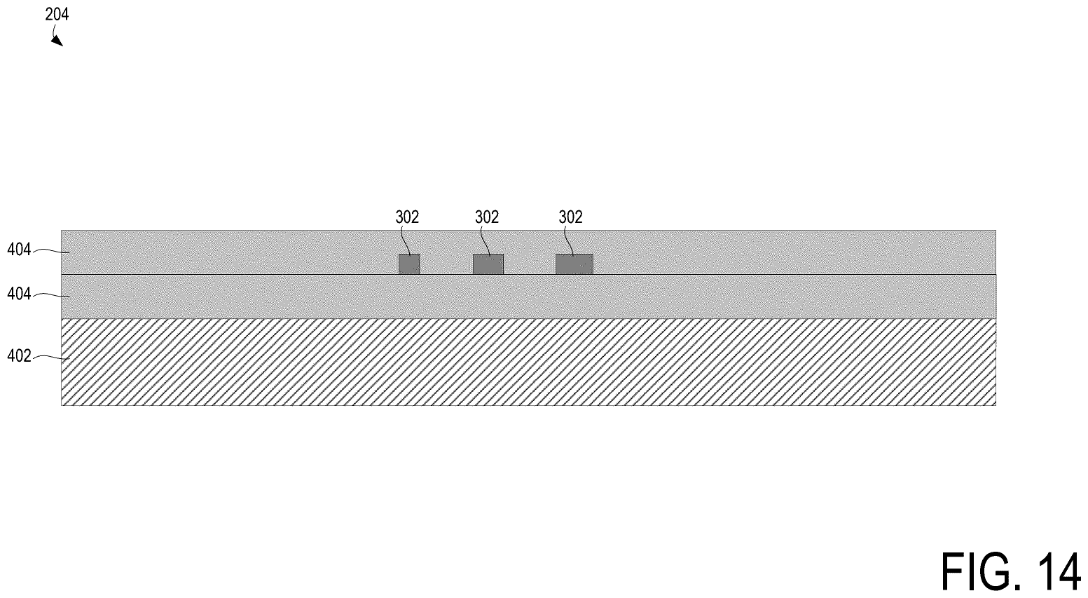

In block 1006, the waveguide layer 1202 may be patterned, removing some of the waveguide layer 1202 and forming components such as waveguides 302, as shown in FIG. 13. In some embodiments, additional structures may be formed, such as microring resonators, couplers, splitters, filters, etc. In some embodiments, some or all of the structure of the waveguides 302 may be formed using additive manufacturing instead of subtractive manufacturing. In some embodiments, active components may be created on the dielectric layer 404, such as by doping the waveguide layer 1202. In block 1008, a dielectric layer 404 is formed on the waveguides 302, as shown in FIG. 14.

It should be appreciated that either of the dielectric layers 404 applied in block 1002 and 1008 may be any suitable material described above for the dielectric layers 404, and that the waveguides 302 may be any suitable material described above for the waveguides 302. In some embodiments, the waveguides on a single layer may be different materials or have different heights, in which case additional steps may be required to form the structure on a single dielectric layer 404.

In block 1010, if an additional layer of waveguides 302 is to be formed, the method 1000 loops back to block 1004 to deposit an additional waveguide layer 1202 on the dielectric layer 404. Any suitable number of layers of waveguides 302 may be formed, such as 2-10. If no more layers of waveguides 302 are to be formed, the method 1000 proceeds to block 1012, in which the PIC die 204 is mounted on an EIC die, such as by using an array of solder balls or using hybrid bonding. In some embodiments, two or more PIC dies 204 may be mounted together, such as by using an array of solder balls or using hybrid bonding. It should be appreciated that additional steps of the method 1000 may be performed as well, such as patterning electric traces on various layers of the PIC die 204. Additional packaging or processing steps, such as mounting the EIC die on a circuit board 102, may be performed before and/or after the PIC die 204 is mounted on the EIC die.

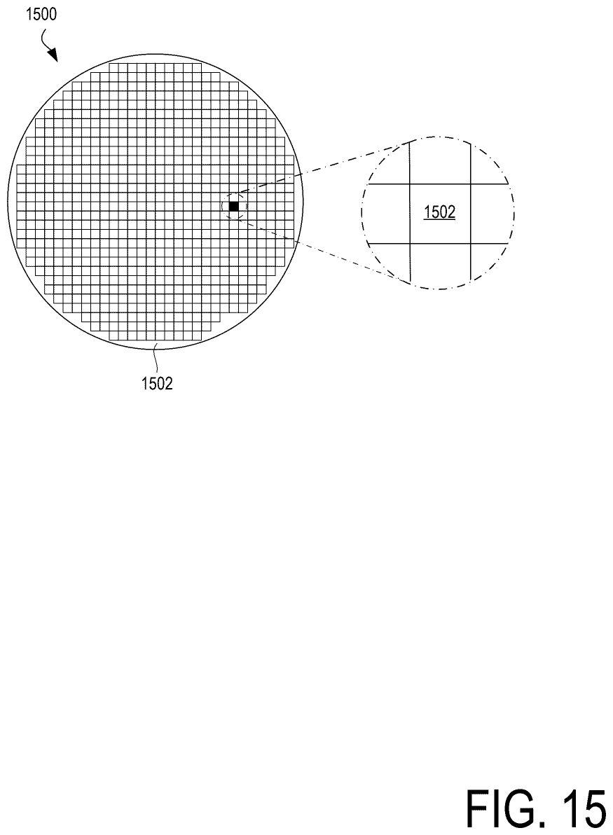

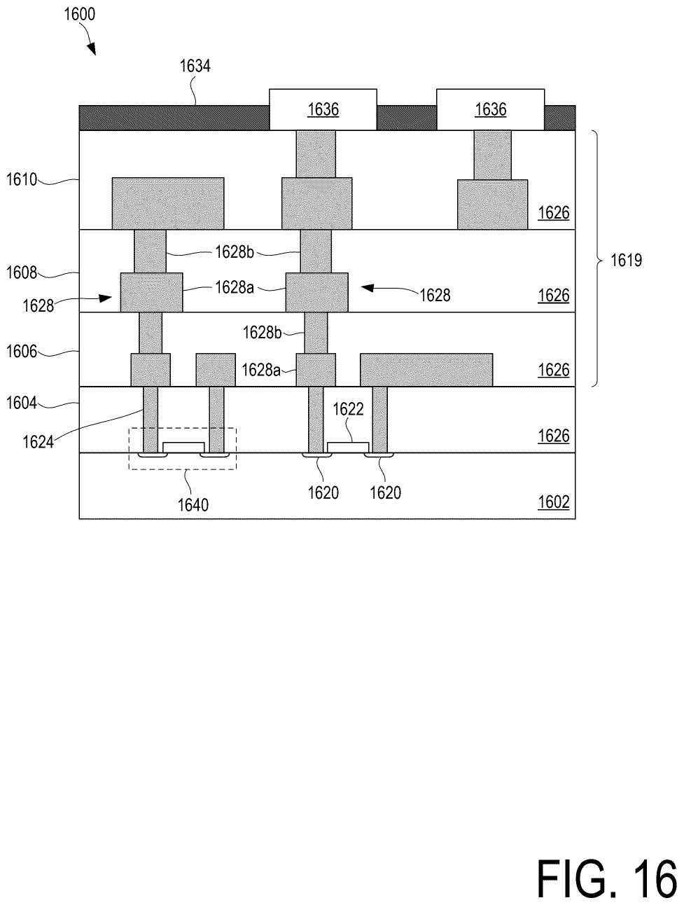

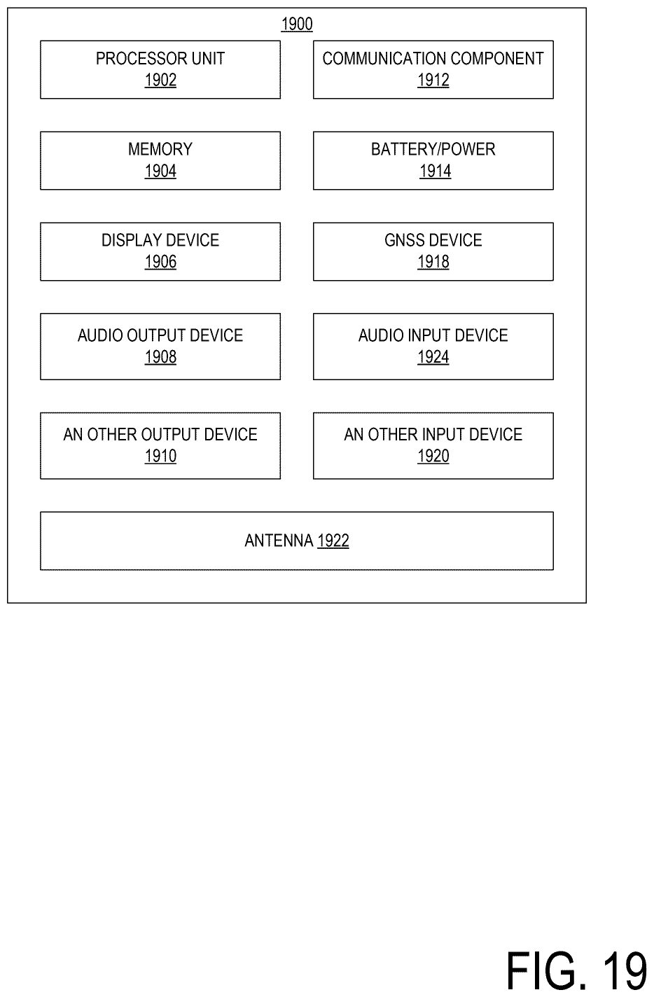

FIG. 15 is a top view of a wafer 1500 and dies 1502 that may be included in any of the integrated circuit components 100 disclosed herein (e.g., as any suitable ones of the dies 202, 204, 206, 208). The wafer 1500 may be composed of semiconductor material and may include one or more dies 1502 having integrated circuit structures formed on a surface of the wafer 1500. The individual dies 1502 may be a repeating unit of an integrated circuit product that includes any suitable integrated circuit. After the fabrication of the semiconductor product is complete, the wafer 1500 may undergo a singulation process in which the dies 1502 are separated from one another to provide discrete “chips” of the integrated circuit product. The die 1502 may be any of the dies 202, 204, 206, 208 disclosed herein. The die 1502 may include one or more transistors (e.g., some of the transistors 1640 of FIG. 16, discussed below), supporting circuitry to route electrical signals to the transistors, passive components (e.g., signal traces, resistors, capacitors, or inductors), and/or any other integrated circuit components. In some embodiments, the wafer 1500 or the die 1502 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 1502. For example, a memory array formed by multiple memory devices may be formed on a same die 1502 as a processor unit (e.g., the processor unit 1902 of FIG. 19) or other logic that is configured to store information in the memory devices or execute instructions stored in the memory array. Various ones of the integrated circuit components 100 disclosed herein may be manufactured using a die-to-wafer assembly technique in which some dies 202, 204, 206, 208 are attached to a wafer 1500 that include others of the dies 202, 204, 206, 208, and the wafer 1500 is subsequently singulated.

FIG. 16 is a cross-sectional side view of an integrated circuit device 1600 that may be included in any of the integrated circuit components 100 disclosed herein (e.g., in any of the dies 202, 204, 206, 208). One or more of the integrated circuit devices 1600 may be included in one or more dies 1502 (FIG. 15). The integrated circuit device 1600 may be formed on a die substrate 1602 (e.g., the wafer 1500 of FIG. 15) and may be included in a die (e.g., the die 1502 of FIG. 15). The die substrate 1602 may be a semiconductor substrate composed of semiconductor material systems including, for example, n-type or p-type materials systems (or a combination of both). The die substrate 1602 may include, for example, a crystalline substrate formed using a bulk silicon or a silicon-on-insulator (SOI) substructure. In some embodiments, the die substrate 1602 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 1602. Although a few examples of materials from which the die substrate 1602 may be formed are described here, any material that may serve as a foundation for an integrated circuit device 1600 may be used. The die substrate 1602 may be part of a singulated die (e.g., the dies 1502 of FIG. 15) or a wafer (e.g., the wafer 1500 of FIG. 15).

The integrated circuit device 1600 may include one or more device layers 1604 disposed on the die substrate 1602. The device layer 1604 may include features of one or more transistors 1640 (e.g., metal oxide semiconductor field-effect transistors (MOSFETs)) formed on the die substrate 1602. The transistors 1640 may include, for example, one or more source and/or drain (S/D) regions 1620, a gate 1622 to control current flow between the S/D regions 1620, and one or more S/D contacts 1624 to route electrical signals to/from the S/D regions 1620. The transistors 1640 may include additional features not depicted for the sake of clarity, such as device isolation regions, gate contacts, and the like. The transistors 1640 are not limited to the type and configuration depicted in FIG. 16 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

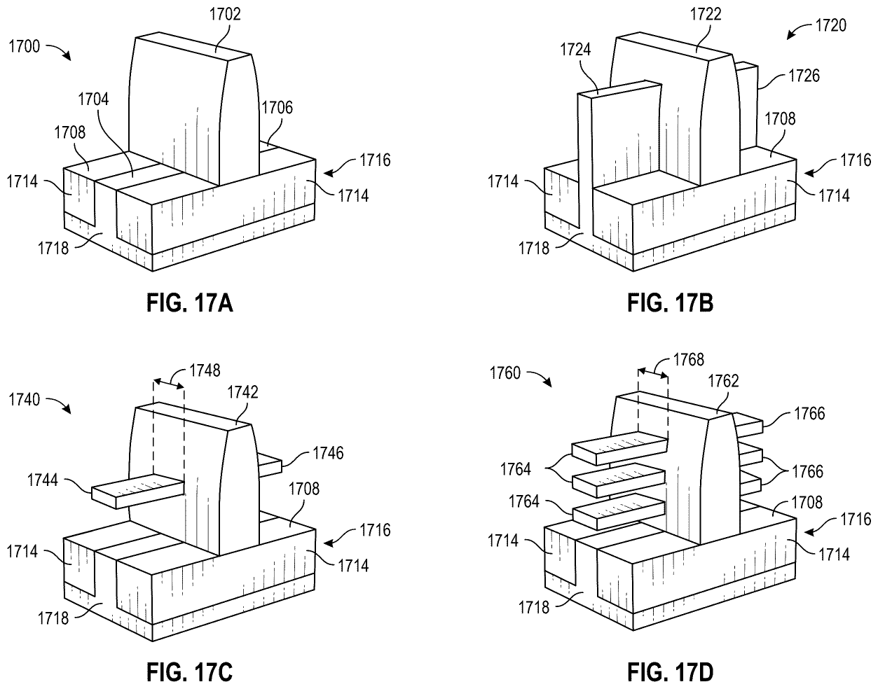

FIGS. 17A-17D are simplified perspective views of example planar, FinFET, gate-all-around, and stacked gate-all-around transistors. The transistors illustrated in FIGS. 17A-17D are formed on a substrate 1716 having a surface 1708. Isolation regions 1714 separate the source and drain regions of the transistors from other transistors and from a bulk region 1718 of the substrate 1716.

FIG. 17A is a perspective view of an example planar transistor 1700 comprising a gate 1702 that controls current flow between a source region 1704 and a drain region 1706. The transistor 1700 is planar in that the source region 1704 and the drain region 1706 are planar with respect to the substrate surface 1708.

FIG. 17B is a perspective view of an example FinFET transistor 1720 comprising a gate 1722 that controls current flow between a source region 1724 and a drain region 1726. The transistor 1720 is non-planar in that the source region 1724 and the drain region 1726 comprise “fins” that extend upwards from the substrate surface 1728. As the gate 1722 encompasses three sides of the semiconductor fin that extends from the source region 1724 to the drain region 1726, the transistor 1720 can be considered a tri-gate transistor. FIG. 17B illustrates one S/D fin extending through the gate 1722, but multiple S/D fins can extend through the gate of a FinFET transistor.

FIG. 17C is a perspective view of a gate-all-around (GAA) transistor 1740 comprising a gate 1742 that controls current flow between a source region 1744 and a drain region 1746. The transistor 1740 is non-planar in that the source region 1744 and the drain region 1746 are elevated from the substrate surface 1728.

FIG. 17D is a perspective view of a GAA transistor 1760 comprising a gate 1762 that controls current flow between multiple elevated source regions 1764 and multiple elevated drain regions 1766. The transistor 1760 is a stacked GAA transistor as the gate controls the flow of current between multiple elevated S/D regions stacked on top of each other. The transistors 1740 and 1760 are considered gate-all-around transistors as the gates encompass all sides of the semiconductor portions that extends from the source regions to the drain regions. The transistors 1740 and 1760 can alternatively be referred to as nanowire, nanosheet, or nanoribbon transistors depending on the width (e.g., widths 1748 and 1768 of transistors 1740 and 1760, respectively) of the semiconductor portions extending through the gate.

Returning to FIG. 16, a transistor 1640 may include a gate 1622 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 1640 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 1640 along the source-channel-drain direction, the gate electrode may consist of a U-shaped structure that includes a bottom portion substantially parallel to the surface of the die substrate 1602 and two sidewall portions that are substantially perpendicular to the top surface of the die substrate 1602. In other embodiments, at least one of the metal layers that form the gate electrode may simply be a planar layer that is substantially parallel to the top surface of the die substrate 1602 and does not include sidewall portions substantially perpendicular to the top surface of the die substrate 1602. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 1620 may be formed within the die substrate 1602 adjacent to the gate 1622 of individual transistors 1640. The S/D regions 1620 may be formed using an implantation/diffusion process or an etching/deposition process, for example. In the former process, dopants such as boron, aluminum, antimony, phosphorous, or arsenic may be ion-implanted into the die substrate 1602 to form the S/D regions 1620. An annealing process that activates the dopants and causes them to diffuse farther into the die substrate 1602 may follow the ion-implantation process. In the latter process, the die substrate 1602 may first be etched to form recesses at the locations of the S/D regions 1620. An epitaxial deposition process may then be carried out to fill the recesses with material that is used to fabricate the S/D regions 1620. In some implementations, the S/D regions 1620 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 1620 may be formed using one or more alternate semiconductor materials such as germanium or a group III-V material or alloy. In further embodiments, one or more layers of metal and/or metal alloys may be used to form the S/D regions 1620.

Electrical signals, such as power and/or input/output (I/O) signals, may be routed to and/or from the devices (e.g., transistors 1640) of the device layer 1604 through one or more interconnect layers disposed on the device layer 1604 (illustrated in FIG. 16 as interconnect layers 1606-1610). For example, electrically conductive features of the device layer 1604 (e.g., the gate 1622 and the S/D contacts 1624) may be electrically coupled with the interconnect structures 1628 of the interconnect layers 1606-1610. The one or more interconnect layers 1606-1610 may form a metallization stack (also referred to as an “ILD stack”) 1619 of the integrated circuit device 1600.

The interconnect structures 1628 may be arranged within the interconnect layers 1606-1610 to route electrical signals according to a wide variety of designs; in particular, the arrangement is not limited to the particular configuration of interconnect structures 1628 depicted in FIG. 16. Although a particular number of interconnect layers 1606-1610 is depicted in FIG. 16, embodiments of the present disclosure include integrated circuit devices having more or fewer interconnect layers than depicted.

In some embodiments, the interconnect structures 1628 may include lines 1628a and/or vias 1628b filled with an electrically conductive material such as a metal. The lines 1628a may be arranged to route electrical signals in a direction of a plane that is substantially parallel with a surface of the die substrate 1602 upon which the device layer 1604 is formed. For example, the lines 1628a may route electrical signals in a direction in and out of the page and/or in a direction across the page. The vias 1628b may be arranged to route electrical signals in a direction of a plane that is substantially perpendicular to the surface of the die substrate 1602 upon which the device layer 1604 is formed. In some embodiments, the vias 1628b may electrically couple lines 1628a of different interconnect layers 1606-1610 together.

The interconnect layers 1606-1610 may include a dielectric material 1626 disposed between the interconnect structures 1628, as shown in FIG. 16. In some embodiments, dielectric material 1626 disposed between the interconnect structures 1628 in different ones of the interconnect layers 1606-1610 may have different compositions; in other embodiments, the composition of the dielectric material 1626 between different interconnect layers 1606-1610 may be the same. The device layer 1604 may include a dielectric material 1626 disposed between the transistors 1640 and a bottom layer of the metallization stack as well. The dielectric material 1626 included in the device layer 1604 may have a different composition than the dielectric material 1626 included in the interconnect layers 1606-1610; in other embodiments, the composition of the dielectric material 1626 in the device layer 1604 may be the same as a dielectric material 1626 included in any one of the interconnect layers 1606-1610.

A first interconnect layer 1606 (referred to as Metal 1 or “M1”) may be formed directly on the device layer 1604. In some embodiments, the first interconnect layer 1606 may include lines 1628a and/or vias 1628b, as shown. The lines 1628a of the first interconnect layer 1606 may be coupled with contacts (e.g., the S/D contacts 1624) of the device layer 1604. The vias 1628b of the first interconnect layer 1606 may be coupled with the lines 1628a of a second interconnect layer 1608.

The second interconnect layer 1608 (referred to as Metal 2 or “M2”) may be formed directly on the first interconnect layer 1606. In some embodiments, the second interconnect layer 1608 may include via 1628b to couple the lines 1628 of the second interconnect layer 1608 with the lines 1628a of a third interconnect layer 1610. Although the lines 1628a and the vias 1628b are structurally delineated with a line within individual interconnect layers for the sake of clarity, the lines 1628a and the vias 1628b may be structurally and/or materially contiguous (e.g., simultaneously filled during a dual-damascene process) in some embodiments.

The third interconnect layer 1610 (referred to as Metal 3 or “M3”) (and additional interconnect layers, as desired) may be formed in succession on the second interconnect layer 1608 according to similar techniques and configurations described in connection with the second interconnect layer 1608 or the first interconnect layer 1606. In some embodiments, the interconnect layers that are “higher up” in the metallization stack 1619 in the integrated circuit device 1600 (i.e., farther away from the device layer 1604) may be thicker that the interconnect layers that are lower in the metallization stack 1619, with lines 1628a and vias 1628b in the higher interconnect layers being thicker than those in the lower interconnect layers.

The integrated circuit device 1600 may include a solder resist material 1634 (e.g., polyimide or similar material) and one or more conductive contacts 1636 formed on the interconnect layers 1606-1610. In FIG. 16, the conductive contacts 1636 are illustrated as taking the form of bond pads. The conductive contacts 1636 may be electrically coupled with the interconnect structures 1628 and configured to route the electrical signals of the transistor(s) 1640 to external devices. For example, solder bonds may be formed on the one or more conductive contacts 1636 to mechanically and/or electrically couple an integrated circuit die including the integrated circuit device 1600 with another component (e.g., a printed circuit board). The integrated circuit device 1600 may include additional or alternate structures to route the electrical signals from the interconnect layers 1606-1610; for example, the conductive contacts 1636 may include other analogous features (e.g., posts) that route the electrical signals to external components. The conductive contacts 1636 may serve as the conductive contacts or solder balls 212, as appropriate.

In some embodiments in which the integrated circuit device 1600 is a double-sided die, the integrated circuit device 1600 may include another metallization stack (not shown) on the opposite side of the device layer(s) 1604. This metallization stack may include multiple interconnect layers as discussed above with reference to the interconnect layers 1606-1610, to provide conductive pathways (e.g., including conductive lines and vias) between the device layer(s) 1604 and additional conductive contacts (not shown) on the opposite side of the integrated circuit device 1600 from the conductive contacts 1636. These additional conductive contacts may serve as the conductive contacts or solder balls 212, as appropriate.

In other embodiments in which the integrated circuit device 1600 is a double-sided die, the integrated circuit device 1600 may include one or more through silicon vias (TSVs) through the die substrate 1602; these TSVs may make contact with the device layer(s) 1604, and may provide conductive pathways between the device layer(s) 1604 and additional conductive contacts (not shown) on the opposite side of the integrated circuit device 1600 from the conductive contacts 1636. These additional conductive contacts may serve as the conductive contacts or solder balls 212, as appropriate. In some embodiments, TSVs extending through the substrate can be used for routing power and ground signals from conductive contacts on the opposite side of the integrated circuit device 1600 from the conductive contacts 1636 to the transistors 1640 and any other components integrated into the die 1600, and the metallization stack 1619 can be used to route I/O signals from the conductive contacts 1636 to transistors 1640 and any other components integrated into the die 1600.

Multiple integrated circuit devices 1600 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

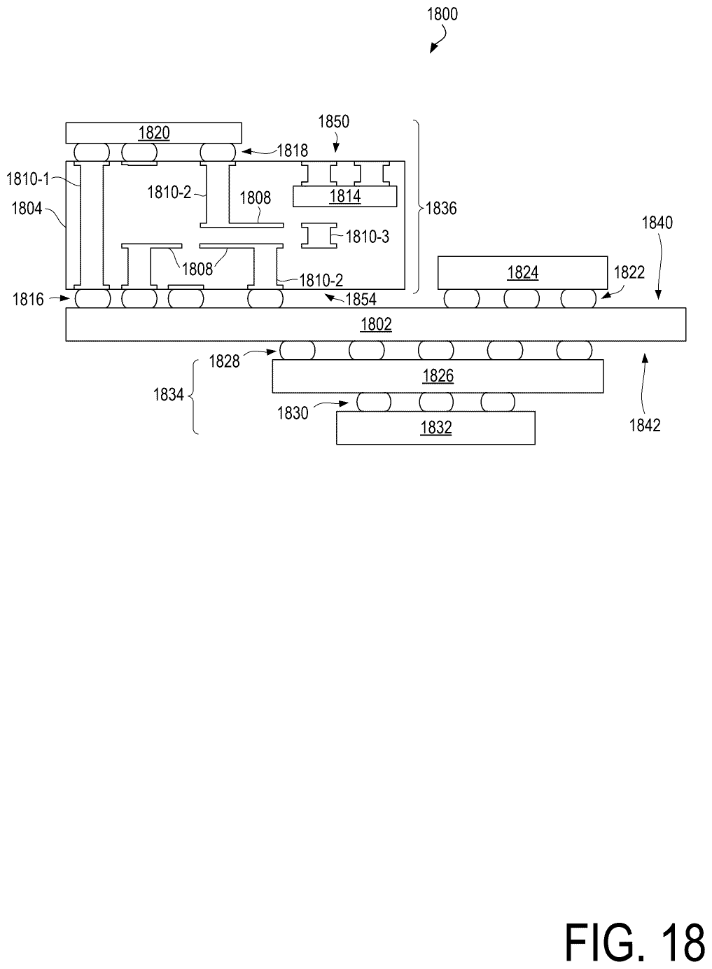

FIG. 18 is a cross-sectional side view of an integrated circuit device assembly 1800 that may include any of the integrated circuit components 100 disclosed herein. In some embodiments, the integrated circuit device assembly 1800 may be an integrated circuit component 100. The integrated circuit device assembly 1800 includes a number of components disposed on a circuit board 1802 (which may be a motherboard, system board, mainboard, etc.). The integrated circuit device assembly 1800 includes components disposed on a first face 1840 of the circuit board 1802 and an opposing second face 1842 of the circuit board 1802; generally, components may be disposed on one or both faces 1840 and 1842. Any of the integrated circuit components discussed below with reference to the integrated circuit device assembly 1800 may take the form of any suitable ones of the embodiments of the integrated circuit components 100 disclosed herein.

In some embodiments, the circuit board 1802 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1802. In other embodiments, the circuit board 1802 may be a non-PCB substrate. In some embodiments the circuit board 1802 may be, for example, the circuit board 102. The integrated circuit device assembly 1800 illustrated in FIG. 18 includes a package-on-interposer structure 1836 coupled to the first face 1840 of the circuit board 1802 by coupling components 1816. The coupling components 1816 may electrically and mechanically couple the package-on-interposer structure 1836 to the circuit board 1802, and may include solder balls (as shown in FIG. 18), pins (e.g., as part of a pin grid array (PGA), contacts (e.g., as part of a land grid array (LGA)), male and female portions of a socket, an adhesive, an underfill material, and/or any other suitable electrical and/or mechanical coupling structure. The coupling components 1816 may serve as the coupling components illustrated or described for any of the substrate assembly or substrate assembly components described herein, as appropriate.

The package-on-interposer structure 1836 may include an integrated circuit component 1820 coupled to an interposer 1804 by coupling components 1818. The coupling components 1818 may take any suitable form for the application, such as the forms discussed above with reference to the coupling components 1816. Although a single integrated circuit component 1820 is shown in FIG. 18, multiple integrated circuit components may be coupled to the interposer 1804; indeed, additional interposers may be coupled to the interposer 1804. The interposer 1804 may provide an intervening substrate used to bridge the circuit board 1802 and the integrated circuit component 1820.

The integrated circuit component 1820 may be a packaged or unpacked integrated circuit product that includes one or more integrated circuit dies (e.g., the die 1502 of FIG. 15, the integrated circuit device 1600 of FIG. 16) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 1820, a single monolithic integrated circuit die comprises solder bumps attached to contacts on the die. The solder bumps allow the die to be directly attached to the interposer 1804. The integrated circuit component 1820 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 1820 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 1820 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 1820 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 1804 may spread connections to a wider pitch or reroute a connection to a different connection. For example, the interposer 1804 may couple the integrated circuit component 1820 to a set of ball grid array (BGA) conductive contacts of the coupling components 1816 for coupling to the circuit board 1802. In the embodiment illustrated in FIG. 18, the integrated circuit component 1820 and the circuit board 1802 are attached to opposing sides of the interposer 1804; in other embodiments, the integrated circuit component 1820 and the circuit board 1802 may be attached to a same side of the interposer 1804. In some embodiments, three or more components may be interconnected by way of the interposer 1804.

In some embodiments, the interposer 1804 may be formed as a PCB, including multiple metal layers separated from one another by layers of dielectric material and interconnected by electrically conductive vias. In some embodiments, the interposer 1804 may be formed of an epoxy resin, a fiberglass-reinforced epoxy resin, an epoxy resin with inorganic fillers, a ceramic material, or a polymer material such as polyimide. In some embodiments, the interposer 1804 may be formed of alternate rigid or flexible materials that may include the same materials described above for use in a semiconductor substrate, such as silicon, germanium, and other group III-V and group IV materials. The interposer 1804 may include metal interconnects 1808 and vias 1810, including but not limited to through hole vias 1810-1 (that extend from a first face 1850 of the interposer 1804 to a second face 1854 of the interposer 1804), blind vias 1810-2 (that extend from the first or second faces 1850 or 1854 of the interposer 1804 to an internal metal layer), and buried vias 1810-3 (that connect internal metal layers).

In some embodiments, the interposer 1804 can comprise a silicon interposer. Through silicon vias (TSV) extending through the silicon interposer can connect connections on a first face of a silicon interposer to an opposing second face of the silicon interposer. In some embodiments, an interposer 1804 comprising a silicon interposer can further comprise one or more routing layers to route connections on a first face of the interposer 1804 to an opposing second face of the interposer 1804.

The interposer 1804 may further include embedded devices 1814, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1804. The package-on-interposer structure 1836 may take the form of any of the package-on-interposer structures known in the art.

The integrated circuit device assembly 1800 may include an integrated circuit component 1824 coupled to the first face 1840 of the circuit board 1802 by coupling components 1822. The coupling components 1822 may take the form of any of the embodiments discussed above with reference to the coupling components 1816, and the integrated circuit component 1824 may take the form of any of the embodiments discussed above with reference to the integrated circuit component 1820.

The integrated circuit device assembly 1800 illustrated in FIG. 18 includes a package-on-package structure 1834 coupled to the second face 1842 of the circuit board 1802 by coupling components 1828. The package-on-package structure 1834 may include an integrated circuit component 1826 and an integrated circuit component 1832 coupled together by coupling components 1830 such that the integrated circuit component 1826 is disposed between the circuit board 1802 and the integrated circuit component 1832. The coupling components 1828 and 1830 may take the form of any of the embodiments of the coupling components 1816 discussed above, and the integrated circuit components 1826 and 1832 may take the form of any of the embodiments of the integrated circuit component 1820 discussed above. The package-on-package structure 1834 may be configured in accordance with any of the package-on-package structures known in the art.

FIG. 19 is a block diagram of an example electrical device 1900 that may include one or more of the integrated circuit components 100 disclosed herein. For example, any suitable ones of the components of the electrical device 1900 may include one or more of the integrated circuit device assemblies 1800, integrated circuit components 1820, integrated circuit devices 1600, or integrated circuit dies 1502 disclosed herein, and may be arranged in any of the integrated circuit components 100 disclosed herein. A number of components are illustrated in FIG. 19 as included in the electrical device 1900, but any one or more of these components may be omitted or duplicated, as suitable for the application. In some embodiments, some or all of the components included in the electrical device 1900 may be attached to one or more motherboards mainboards, or system boards. In some embodiments, one or more of these components are fabricated onto a single system-on-a-chip (SoC) die.

Additionally, in various embodiments, the electrical device 1900 may not include one or more of the components illustrated in FIG. 19, but the electrical device 1900 may include interface circuitry for coupling to the one or more components. For example, the electrical device 1900 may not include a display device 1906, but may include display device interface circuitry (e.g., a connector and driver circuitry) to which a display device 1906 may be coupled. In another set of examples, the electrical device 1900 may not include an audio input device 1924 or an audio output device 1908, but may include audio input or output device interface circuitry (e.g., connectors and supporting circuitry) to which an audio input device 1924 or audio output device 1908 may be coupled.

The electrical device 1900 may include one or more processor units 1902 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1902 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 1900 may include a memory 1904, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1904 may include memory that is located on the same integrated circuit die as the processor unit 1902. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 1900 can comprise one or more processor units 1902 that are heterogeneous or asymmetric to another processor unit 1902 in the electrical device 1900. There can be a variety of differences between the processing units 1902 in a system in terms of a spectrum of metrics of merit including architectural, microarchitectural, thermal, power consumption characteristics, and the like. These differences can effectively manifest themselves as asymmetry and heterogeneity among the processor units 1902 in the electrical device 1900.

In some embodiments, the electrical device 1900 may include a communication component 1912 (e.g., one or more communication components). For example, the communication component 1912 can manage wireless communications for the transfer of data to and from the electrical device 1900. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1912 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16—2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1912 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1912 may operate in accordance with other wireless protocols in other embodiments. The electrical device 1900 may include an antenna 1922 to facilitate wireless communications and/or to receive other wireless communications (such as AM or FM radio transmissions).

In some embodiments, the communication component 1912 may manage wired communications, such as electrical, optical, or any other suitable communication protocols (e.g., IEEE 802.3 Ethernet standards). As noted above, the communication component 1912 may include multiple communication components. For instance, a first communication component 1912 may be dedicated to shorter-range wireless communications such as Wi-Fi or Bluetooth, and a second communication component 1912 may be dedicated to longer-range wireless communications such as global positioning system (GPS), EDGE, GPRS, CDMA, WiMAX, LTE, EV-DO, or others. In some embodiments, a first communication component 1912 may be dedicated to wireless communications, and a second communication component 1912 may be dedicated to wired communications.

The electrical device 1900 may include battery/power circuitry 1914. The battery/power circuitry 1914 may include one or more energy storage devices (e.g., batteries or capacitors) and/or circuitry for coupling components of the electrical device 1900 to an energy source separate from the electrical device 1900 (e.g., AC line power).

The electrical device 1900 may include a display device 1906 (or corresponding interface circuitry, as discussed above). The display device 1906 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1900 may include an audio output device 1908 (or corresponding interface circuitry, as discussed above). The audio output device 1908 may include any embedded or wired or wirelessly connected external device that generates an audible indicator, such as speakers, headsets, or earbuds.

The electrical device 1900 may include an audio input device 1924 (or corresponding interface circuitry, as discussed above). The audio input device 1924 may include any embedded or wired or wirelessly connected device that generates a signal representative of a sound, such as microphones, microphone arrays, or digital instruments (e.g., instruments having a musical instrument digital interface (MIDI) output). The electrical device 1900 may include a Global Navigation Satellite System (GNSS) device 1918 (or corresponding interface circuitry, as discussed above), such as a Global Positioning System (GPS) device. The GNSS device 1918 may be in communication with a satellite-based system and may determine a geolocation of the electrical device 1900 based on information received from one or more GNSS satellites, as known in the art.

The electrical device 1900 may include an other output device 1910 (or corresponding interface circuitry, as discussed above). Examples of the other output device 1910 may include an audio codec, a video codec, a printer, a wired or wireless transmitter for providing information to other devices, or an additional storage device.

The electrical device 1900 may include an other input device 1920 (or corresponding interface circuitry, as discussed above). Examples of the other input device 1920 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1900 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1900 may be any other electronic device that processes data. In some embodiments, the electrical device 1900 may comprise multiple discrete physical components. Given the range of devices that the electrical device 1900 can be manifested as in various embodiments, in some embodiments, the electrical device 1900 can be referred to as a computing device or a computing system.

### EXAMPLES

Illustrative examples of the technologies disclosed herein are provided below. An embodiment of the technologies may include any one or more, and any combination of, the examples described below.

Example 1 includes a photonic integrated circuit (PIC) die comprising a substrate layer; a first layer comprising a first plurality of waveguides defined therein, wherein the first layer is above the substrate layer, wherein individual waveguides of the first plurality of waveguides have a width that is different from those of neighboring waveguides of the first plurality of waveguides; and a second layer comprising a second plurality of waveguides defined therein, wherein the second layer is above the first layer, wherein individual waveguides of the second plurality of waveguides have a width that is different from those of neighboring waveguides of the second plurality of waveguides, wherein individual waveguides of the second plurality of waveguides have a width that is different from those of neighboring waveguides of the first plurality of waveguides.

Example 2 includes the subject matter of Example 1, and wherein individual waveguides of the first plurality of waveguides have a difference in width of at least 5% compared to neighboring waveguides of the first plurality of waveguides.

Example 3 includes the subject matter of any of Examples 1 and 2, and wherein individual waveguides of the first plurality of waveguides have a difference in width of at least 5% compared to neighboring waveguides of the second plurality of waveguides.

Example 4 includes the subject matter of any of Examples 1-3, and wherein individual waveguides of the first plurality of waveguides have a difference in core index of refraction of at least 0.1 compared to neighboring waveguides of the second plurality of waveguides.

Example 5 includes the subject matter of any of Examples 1-4, and wherein individual waveguides of the first plurality of waveguides have a difference in cladding index of refraction of at least 0.1 compared to neighboring waveguides of the second plurality of waveguides.

Example 6 includes the subject matter of any of Examples 1-5, and wherein individual waveguides of the first plurality of waveguides have a propagation constant different from neighboring waveguides of the first and second plurality of waveguides, wherein individual waveguides of the first plurality of waveguides have a coupling constant for individual neighboring waveguides of the first or second plurality and waveguides, wherein, for individual waveguides of the first plurality of waveguides and neighboring waveguides of the first and second plurality of waveguides, a ratio of the difference in propagation constants and the coupling constant is at least 20.

Example 7 includes the subject matter of any of Examples 1-6, and wherein individual waveguides of the first plurality of waveguides have a crosstalk with other waveguides of the first and second plurality of waveguides that is less than −30 decibels.

Example 8 includes the subject matter of any of Examples 1-7, and wherein a pitch between waveguides of the first plurality of waveguides is less than twice an operating wavelength of the first plurality of waveguides, wherein a vertical distance between the first plurality of waveguides and the second plurality of waveguides is less than twice the operating wavelength of the first plurality of waveguides.

Example 9 includes the subject matter of any of Examples 1-8, and wherein a pitch between waveguides of the first plurality of waveguides is less than an operating wavelength of the first plurality of waveguides, wherein a vertical distance between the first plurality of waveguides and the second plurality of waveguides is less than the operating wavelength of the first plurality of waveguides.

Example 10 includes the subject matter of any of Examples 1-9, and wherein the first plurality of waveguides comprises at least four waveguides, wherein the second plurality of waveguides comprises at least four waveguides.

Example 11 includes the subject matter of any of Examples 1-10, and wherein the PIC die is to utilize individual waveguides of the first and second plurality of waveguides at a plurality of wavelengths using wavelength-division multiplexing.

Example 12 includes the subject matter of any of Examples 1-11, and wherein the PIC die is to utilize individual waveguides of the first and second plurality of waveguides at a plurality of spatial modes using spatial mode-division multiplexing.

Example 13 includes an integrated circuit component comprising the PIC die of any of Examples 1-12, further comprising an electronic integrated circuit (EIC) die mated with the PIC die; a plurality of solder balls positioned between the EIC die and the PIC die, wherein individual solder balls of the plurality of solder balls are adjacent individual contact pads of the plurality of contact pads of the PIC die; and a circuit board mated to the EIC die.

Example 14 includes a photonic integrated circuit (PIC) die comprising a substrate layer; a first layer comprising a first plurality of waveguides defined therein, wherein the first layer is above the substrate layer, wherein individual waveguides of the first plurality of waveguides have a propagation constant that is different from those of neighboring waveguides of the first plurality of waveguides; and a second layer comprising a second plurality of waveguides defined therein, wherein the second layer is above the first layer, wherein individual waveguides of the second plurality of waveguides have a propagation constant that is different from those of neighboring waveguides of the second plurality of waveguides, wherein individual waveguides of the second plurality of waveguides have a propagation constant that is different from those of neighboring waveguides of the first plurality of waveguides.

Example 15 includes the subject matter of Example 14, and wherein individual waveguides of the first plurality of waveguides have a difference in propagation constant of at least 5% compared to neighboring waveguides of the first and second plurality of waveguides.

Example 16 includes the subject matter of any of Examples 14 and 15, and wherein individual waveguides of the first plurality of waveguides have a difference in width of at least 5% compared to neighboring waveguides of the first plurality of waveguides.

Example 17 includes the subject matter of any of Examples 14-16, and wherein individual waveguides of the first plurality of waveguides have a difference in width of at least 5% compared to neighboring waveguides of the second plurality of waveguides.

Example 18 includes the subject matter of any of Examples 14-17, and wherein individual waveguides of the first plurality of waveguides have a difference in core index of refraction of at least 0.1 compared to neighboring waveguides of the second plurality of waveguides.

Example 19 includes the subject matter of any of Examples 14-18, and wherein individual waveguides of the first plurality of waveguides have a difference in cladding index of refraction of at least 0.1 compared to neighboring waveguides of the second plurality of waveguides.

Example 20 includes the subject matter of any of Examples 14-19, and wherein individual waveguides of the first plurality of waveguides have a propagation constant different from neighboring waveguides of the first and second plurality of waveguides, wherein individual waveguides of the first plurality of waveguides have a coupling constant for individual neighboring waveguides of the first or second plurality and waveguides, wherein, for individual waveguides of the first plurality of waveguides and neighboring waveguides of the first and second plurality of waveguides, a ratio of the difference in propagation constants and the coupling constant is at least 20.

Example 21 includes the subject matter of any of Examples 14-20, and wherein individual waveguides of the first plurality of waveguides have a crosstalk with other waveguides of the first and second plurality of waveguides that is less than −30 decibels.

Example 22 includes the subject matter of any of Examples 14-21, and wherein a pitch between waveguides of the first plurality of waveguides is less than twice an operating wavelength of the first plurality of waveguides, wherein a vertical distance between the first plurality of waveguides and the second plurality of waveguides is less than twice the operating wavelength of the first plurality of waveguides.

Example 23 includes the subject matter of any of Examples 14-22, and wherein a pitch between waveguides of the first plurality of waveguides is less than an operating wavelength of the first plurality of waveguides, wherein a vertical distance between the first plurality of waveguides and the second plurality of waveguides is less than the operating wavelength of the first plurality of waveguides.

Example 24 includes the subject matter of any of Examples 14-23, and wherein the first plurality of waveguides comprises at least four waveguides, wherein the second plurality of waveguides comprises at least four waveguides.

Example 25 includes the subject matter of any of Examples 14-24, and wherein the PIC die is to utilize individual waveguides of the first and second plurality of waveguides at a plurality of wavelengths using wavelength-division multiplexing.

Example 26 includes the subject matter of any of Examples 14-25, and wherein the PIC die is to utilize individual waveguides of the first and second plurality of waveguides at a plurality of spatial modes using spatial mode-division multiplexing.

Example 27 includes an integrated circuit component comprising the PIC die of any of Examples 14-26, further comprising an electronic integrated circuit (EIC) die mated with the PIC die; a plurality of solder balls positioned between the EIC die and the PIC die, wherein individual solder balls of the plurality of solder balls are adjacent individual contact pads of the plurality of contact pads of the PIC die; and a circuit board mated to the EIC die.

Example 28 includes a photonic integrated circuit (PIC) die comprising a substrate layer; and a three-dimensional array of waveguides defined in a plurality of layers above the substrate layer, wherein individual waveguides of the three-dimensional array of waveguides have a propagation constant that is different from neighboring waveguides of the three-dimensional array of waveguides such that crosstalk between individual waveguides of the three-dimensional array of waveguides and neighboring waveguides of the three-dimensional array of waveguides is less than −30 decibels.

Example 29 includes the subject matter of Example 28, and wherein individual waveguides of the three-dimensional array of waveguides have a difference in propagation constant of at least 5% compared to neighboring waveguides of the three-dimensional array of waveguides.

Example 30 includes the subject matter of any of Examples 28 and 29, and wherein individual waveguides of the three-dimensional array of waveguides have a difference in width of at least 5% compared to neighboring waveguides of the three-dimensional array of waveguides.

Example 31 includes the subject matter of any of Examples 28-30, and wherein individual waveguides of the three-dimensional array of waveguides have a difference in width of at least 5% compared to neighboring waveguides of the three-dimensional array of waveguides.

Example 32 includes the subject matter of any of Examples 28-31, and wherein individual waveguides of the three-dimensional array of waveguides have a difference in core index of refraction of at least 0.1 compared to neighboring waveguides of the three-dimensional array of waveguides.

Example 33 includes the subject matter of any of Examples 28-32, and wherein individual waveguides of the three-dimensional array of waveguides have a difference in cladding index of refraction of at least 0.1 compared to neighboring waveguides of the three-dimensional array of waveguides.

Example 34 includes the subject matter of any of Examples 28-33, and wherein individual waveguides of the three-dimensional array of waveguides have a propagation constant different from neighboring waveguides of the three-dimensional array of waveguides, wherein individual waveguides of the three-dimensional array of waveguides have a coupling constant for individual neighboring waveguides of the three-dimensional array of waveguides, wherein, for individual waveguides of the three-dimensional array of waveguides and neighboring waveguides of the three-dimensional array of waveguides, a ratio of the difference in propagation constants and the coupling constant is at least 20.

Example 35 includes the subject matter of any of Examples 28-34, and wherein individual waveguides of the three-dimensional array of waveguides have a crosstalk with other waveguides of the three-dimensional array of waveguides that is less than −30 decibels.

Example 36 includes the subject matter of any of Examples 28-35, and wherein a horizontal pitch and a vertical pitch between waveguides of the three-dimensional array of waveguides is less than twice an operating wavelength of the three-dimensional array of waveguides.

Example 37 includes the subject matter of any of Examples 28-36, and wherein a horizontal pitch and a vertical pitch between waveguides of the three-dimensional array of waveguides is less than an operating wavelength of the three-dimensional array of waveguides.

Example 38 includes the subject matter of any of Examples 28-37, and wherein the three-dimensional array of waveguides comprises at least four layers of at least four waveguides.

Example 39 includes the subject matter of any of Examples 28-38, and wherein the PIC die is to utilize individual waveguides of the three-dimensional array of waveguides at a plurality of wavelengths using wavelength-division multiplexing.

Example 40 includes the subject matter of any of Examples 28-39, and wherein the PIC die is to utilize individual waveguides of the three-dimensional array of waveguides at a plurality of spatial modes using spatial mode-division multiplexing.

Example 41 includes an integrated circuit component comprising the PIC die of any of Examples 28-40, further comprising an electronic integrated circuit (EIC) die mated with the PIC die; a plurality of solder balls positioned between the EIC die and the PIC die, wherein individual solder balls of the plurality of solder balls are adjacent individual contact pads of the plurality of contact pads of the PIC die; and a circuit board mated to the EIC die.

1. A photonic integrated circuit (PIC) die comprising:
a substrate layer;
a first layer comprising a first plurality of waveguides defined therein, wherein the first layer is above the substrate layer, wherein individual waveguides of the first plurality of waveguides have a width that is different from those of neighboring waveguides of the first plurality of waveguides; and
a second layer comprising a second plurality of waveguides defined therein, wherein the second layer is above the first layer, wherein individual waveguides of the second plurality of waveguides have a width that is different from those of neighboring waveguides of the second plurality of waveguides,
wherein individual waveguides of the second plurality of waveguides have a width that is different from those of neighboring waveguides of the first plurality of waveguides.

2. The PIC die of claim 1, wherein individual waveguides of the first plurality of waveguides have a difference in width of at least 5% compared to neighboring waveguides of the first plurality of waveguides.

3. The PIC die of claim 2, wherein individual waveguides of the first plurality of waveguides have a difference in width of at least 5% compared to neighboring waveguides of the second plurality of waveguides.

4. The PIC die of claim 2, wherein individual waveguides of the first plurality of waveguides have a difference in core index of refraction of at least 0.1 compared to neighboring waveguides of the second plurality of waveguides.

5. The PIC die of claim 2, wherein individual waveguides of the first plurality of waveguides have a difference in cladding index of refraction of at least 0.1 compared to neighboring waveguides of the second plurality of waveguides.

6. The PIC die of claim 1, wherein individual waveguides of the first plurality of waveguides have a crosstalk with other waveguides of the first and second plurality of waveguides that is less than −30 decibels.

7. The PIC die of claim 6, wherein a pitch between waveguides of the first plurality of waveguides is less than twice an operating wavelength of the first plurality of waveguides, wherein a vertical distance between the first plurality of waveguides and the second plurality of waveguides is less than twice the operating wavelength of the first plurality of waveguides.

8. The PIC die of claim 6, wherein a pitch between waveguides of the first plurality of waveguides is less than an operating wavelength of the first plurality of waveguides, wherein a vertical distance between the first plurality of waveguides and the second plurality of waveguides is less than the operating wavelength of the first plurality of waveguides.

9. The PIC die of claim 1, wherein the first plurality of waveguides comprises at least four waveguides, wherein the second plurality of waveguides comprises at least four waveguides.

10. The PIC die of claim 1, wherein the PIC die is to utilize individual waveguides of the first and second plurality of waveguides at a plurality of wavelengths using wavelength-division multiplexing.

11. The PIC die of claim 1, wherein the PIC die is to utilize individual waveguides of the first and second plurality of waveguides at a plurality of spatial modes using spatial mode-division multiplexing.

12. An integrated circuit component comprising the PIC die of claim 1, further comprising:
an electronic integrated circuit (EIC) die mated with the PIC die;
a plurality of solder balls positioned between the EIC die and the PIC die, wherein individual solder balls of the plurality of solder balls are adjacent individual contact pads of the plurality of contact pads of the PIC die; and
a circuit board mated to the EIC die.

13. A photonic integrated circuit (PIC) die comprising:
a substrate layer;
a first layer comprising a first plurality of waveguides defined therein, wherein the first layer is above the substrate layer, wherein individual waveguides of the first plurality of waveguides have a propagation constant that is different from those of neighboring waveguides of the first plurality of waveguides; and
a second layer comprising a second plurality of waveguides defined therein, wherein the second layer is above the first layer, wherein individual waveguides of the second plurality of waveguides have a propagation constant that is different from those of neighboring waveguides of the second plurality of waveguides,
wherein individual waveguides of the second plurality of waveguides have a propagation constant that is different from those of neighboring waveguides of the first plurality of waveguides.

14. The PIC die of claim 13, wherein individual waveguides of the first plurality of waveguides have a difference in propagation constant of at least 5% compared to neighboring waveguides of the first and second plurality of waveguides.

15. The PIC die of claim 13, wherein individual waveguides of the first plurality of waveguides have a propagation constant different from neighboring waveguides of the first and second plurality of waveguides,
wherein individual waveguides of the first plurality of waveguides have a coupling constant for individual neighboring waveguides of the first or second plurality and waveguides,
wherein, for individual waveguides of the first plurality of waveguides and neighboring waveguides of the first and second plurality of waveguides, a ratio of the difference in propagation constants and the coupling constant is at least 20.

16. A photonic integrated circuit (PIC) die comprising:
a substrate layer; and
a three-dimensional array of waveguides defined in a plurality of layers above the substrate layer, wherein individual waveguides of the three-dimensional array of waveguides have a propagation constant that is different from neighboring waveguides of the three-dimensional array of waveguides such that crosstalk between individual waveguides of the three-dimensional array of waveguides and neighboring waveguides of the three-dimensional array of waveguides is less than −30 decibels.

17. The PIC die of claim 16, wherein individual waveguides of the three-dimensional array of waveguides have a difference in propagation constant of at least 5% compared to neighboring waveguides of the three-dimensional array of waveguides.

18. The PIC die of claim 16, wherein individual waveguides of the three-dimensional array of waveguides have a difference in width of at least 5% compared to neighboring waveguides of the three-dimensional array of waveguides.

19. The PIC die of claim 18, wherein individual waveguides of the three-dimensional array of waveguides have a difference in width of at least 5% compared to neighboring waveguides of the three-dimensional array of waveguides.

20. The PIC die of claim 18, wherein individual waveguides of the three-dimensional array of waveguides have a difference in core index of refraction of at least 0.1 compared to neighboring waveguides of the three-dimensional array of waveguides.
